(19) United States
(12) Patent Application Publication
(10) Pub. No.: US 2021/0333626 A1
(43) Pub. Date: Oct. 28, 2021

(54) LIQUID CRYSTAL DISPLAY DEVICE

(71) Applicant: WUHAN CHINA STAR OPTOELECTRONICS TECHNOLOGY CO., LTD., Wuhan, Hubei (CN)

(72) Inventor: Chengzhi LUO, Wuhan, Hubei (CN)

(21) Appl. No.: 16/472,521

(22) PCT Filed: Apr. 15, 2019
(86) PCT No.: PCT/CN2019/082660

§ 371 Date: Jun. 21, 2019

(30) Foreign Application Priority Data
Dec. 24, 2018 (CN) 201811583960.X

(51) Int. Cl. G02F 1/1335; G02F 1/13357; G02F 1/13363

(52) U.S. Cl. CPC G02F 1/133528; G02F 1/133606; G02F 1/133507; G02F 1/133524; G02F 1/133638

(57) ABSTRACT

Disclosed is a liquid crystal display device, including a common polarizer, a liquid crystal layer and a backlight module; and the backlight module includes: a diffusion sheet, a multilayer film polarizer, a λ/4 wave plate, a light source, a light guide plate and a reflection sheet; the diffusion sheet is disposed under the liquid crystal layer; the multilayer film polarizer includes a plurality of films disposed right under the diffusion sheet; the λ/4 wave plate is disposed between the multilayer film polarizer and the light guide plate; the light guide plate is disposed under the λ/4 wave plate; and the reflection sheet is disposed under the light guide plate.

### FIELD OF THE INVENTION

The present application relates to a display field, and more particularly to a liquid crystal display device.

### BACKGROUND OF THE INVENTION

Thin film transistor-liquid crystal display (TFT-LCD) possesses advantages of low power consumption, high contrast, space saving, etc., and has become the most mainstream display device in the market. The thin film transistor-liquid crystal display includes a backlight, a backlight side polarizing plate, a thin film transistor, a liquid crystal cell, a color filter substrate, and a display side polarizing plate in sequence. In recent years, project development for saving power, high definition, and improving color reproducibility for the thin film transistor-liquid crystal displays, is being promoted. Increasing the transmittance can improve the brightness of the thin film transistor-liquid crystal display and can reduce the power loss, which is the difficulty that all panel makers around the world are currently conquering.

The light transmittance of the thin film transistor-liquid crystal display refers to a ratio of the light intensity before and after the backlight passes through the thin film transistor-liquid crystal display panel. Generally, a thin film transistor-liquid crystal display possesses a light transmittance of only 3% to 10%, that is, more than 90% of light cannot be utilized.

Therefore, as regarding the conventional thin film transistor-liquid crystal display technology, there is also a problem that the transmittance of the liquid crystal display panel is low, and a large amount of incident light is not utilized, and improvement is urgently required.

### SUMMARY OF THE INVENTION

The present application relates to a liquid crystal display device for solving a problem that the transmittance of the liquid crystal display panel is low, and a large amount of incident light is not utilized in the prior art.

To solve the aforesaid problem, the technical solution of the present application is described as follows:

The present application provides a liquid crystal display device, including a common polarizer, a liquid crystal layer and a backlight module;

wherein the common polarizer is disposed on a color film substrate;

the liquid crystal layer is disposed under the common polarizer, and between the common polarizer and the backlight module;

wherein the backlight module further includes: a diffusion sheet, a multilayer film polarizer, a λ/4 wave plate, a light source, a light guide plate and a reflection sheet;

the diffusion sheet is disposed under the liquid crystal layer and is right opposite to the common polarizer;

the multilayer film polarizer includes at least one film disposed right under the diffusion sheet;

the λ/4 wave plate is disposed between the multilayer film polarizer and the light guide plate;

the light guide plate is disposed under the λ/4 wave plate, and a front surface of the light guide plate is a flat surface, and a bottom surface of the light guide plate is a mesh surface; and

the reflection sheet is disposed under the light guide plate and at a bottom of the backlight module.

According to a preferred embodiment provided by the present application, the backlight module is a side light type backlight module or a direct light type backlight module.

According to a preferred embodiment provided by the present application, the multilayer film polarizer is made of polyethylene terephthalate or a polyvinyl alcohol polymer material.

According to a preferred embodiment provided by the present application, a number of layers of the multilayer film polarizer is greater than 500.

According to a preferred embodiment provided by the present application, a total thickness of the multilayer film polarizer does not exceed 100 um.

According to a preferred embodiment provided by the present application, each film of the multilayer film polarizer possesses a thickness of 95 to 195 nm.

According to a preferred embodiment provided by the present application, the diffusion sheet is made of a polymer material of polyethylene terephthalate or polycarbonate as a substrate, and an acrylic resin material is used as a diffusion layer and a protective layer.

According to a preferred embodiment provided by the present application, diffusion particles in the diffusion layer are polymethyl methacrylate particles having irregular particle diameters.

According to a preferred embodiment provided by the present application, the λ/4 wave plate is made of polymer material of polymethyl methacrylate or polyethylene terephthalate.

According to a preferred embodiment provided by the present application, the common polarizer is an iodine-based polyvinyl alcohol type polarizer.

According to a preferred embodiment provided by the present application, a polarization direction of the common polarizer is perpendicular to a direction of the multilayer film polarizer.

The present application further provides a liquid crystal display device, including a common polarizer, a liquid crystal layer and a backlight module;

wherein the common polarizer is disposed on a color film substrate;

the liquid crystal layer is disposed under the common polarizer, and between the common polarizer and the backlight module;

wherein the backlight module further includes: a diffusion sheet, a multilayer film polarizer, a λ/4 wave plate, a light source, a light guide plate and a reflection sheet;

the diffusion sheet is disposed under the liquid crystal layer and is right opposite to the common polarizer;

the multilayer film polarizer includes at least one film disposed right under the diffusion sheet;

the λ/4 wave plate is disposed between the multilayer film polarizer and the light guide plate;

the light guide plate is disposed under the λ/4 wave plate; and

the reflection sheet is disposed under the light guide plate and at a bottom of the backlight module.

According to a preferred embodiment provided by the present application, the backlight module is a side light type backlight module or a direct light type backlight module.

According to a preferred embodiment provided by the present application, the multilayer film polarizer is made of polyethylene terephthalate or a polyvinyl alcohol polymer material.

According to a preferred embodiment provided by the present application, a number of layers of the multilayer film polarizer is greater than 500.

According to a preferred embodiment provided by the present application, a total thickness of the multilayer film polarizer does not exceed 100 um.

According to a preferred embodiment provided by the present application, each film of the multilayer film polarizer possesses a thickness of 95 to 195 nm.

According to a preferred embodiment provided by the present application, the diffusion sheet is made of a polymer material of polyethylene terephthalate or polycarbonate as a substrate, and an acrylic resin material is used as a diffusion layer and a protective layer.

According to a preferred embodiment provided by the present application, diffusion particles in the diffusion layer are polymethyl methacrylate particles having irregular particle diameters.

According to a preferred embodiment provided by the present application, the λ/4 wave plate is made of polymer material of polymethyl methacrylate or polyethylene terephthalate.

Compared with the prior art, the present application replaces the iodine-based polyvinyl alcohol type polarizer on the array substrate side with the multilayer film structure polarizer. The structure of the light guide plate is adjusted so that the incident light is incident at the Brewster angle, and a λ/4 wave plate is added between the multilayer film and the light guide plate. Compared with the iodine-based polyvinyl alcohol type polarizer, the refractive polarizer proposed in the present application can transmit natural light into polarized light, and meanwhile, the light that has not passed through the multilayer film is transmitted after changing the polarization direction, thereby greatly improving the light transmittance.

### BRIEF DESCRIPTION OF THE DRAWINGS

In order to more clearly illustrate the embodiments of the present application, the following figures will be described in the embodiments are briefly introduced. It is obvious that the drawings are only some embodiments of the present application, those of ordinary skill in this field can obtain other figures according to these figures without paying the premise.

FIG. 1 is a liquid crystal display device with a dual brightness enhancement film added to an array substrate according to an embodiment of the present application.

FIG. 2 is a light transmission path diagram of a multilayer film polarizer in a liquid crystal display device according to an embodiment of the present application.

FIG. 3 is a structural diagram of light entering a multilayer film polarizer in a liquid crystal display device according to an embodiment of the present application.

FIG. 4 is a first light-emitting path diagram of a light guide plate in a liquid crystal display device according to an embodiment of the present application.

FIG. 5 is a first structural diagram of a liquid crystal display device according to an embodiment of the present application.

FIG. 6 is a second light-emitting path diagram of a light guide plate in a liquid crystal display device according to an embodiment of the present application.

FIG. 7 is a second structural diagram of a liquid crystal display device according to an embodiment of the present application.

### DETAILED DESCRIPTION OF PREFERRED EMBODIMENTS

For better explaining the technical solution and the effect of the present invention, the present invention will be further described in detail with the accompanying drawings in the specific embodiments. It is clear that the described embodiments are merely part of embodiments of the present invention, but not all embodiments. Based on the embodiments of the present application, all other embodiments to those of skilled in the premise of no creative efforts obtained, should be considered within the scope of protection of the present application.

In the description of the present application, it is to be understood that the terms “center”, “longitudinal”, “transverse”, “length”, “width”, “thickness”, “upper”, “lower”, “front”, “Orientation of “post”, “left”, “right”, “vertical”, “horizontal”, “top”, “bottom”, “inside”, “outside”, “clockwise”, “counterclockwise”, etc. are positional relationships based on the orientations or positional relationships shown in the drawings, and are merely for the convenience of the description of the present application and the simplified description, and do not indicate or imply that the device or component referred to have specific orientations, and are constructed and operated in specific orientations. Therefore, these should not be construed as limiting the present application. Moreover, the terms “first” and “second” are used for descriptive purposes only and are not to be construed as indicating or implying a relative importance or implicitly indicating the number of indicated technical features. Thus, features defining “first” and “second” may include one or more of the features with either explicitly or implicitly. In the description of the present application, “plurality” means two or more unless with being specifically indicated otherwise.

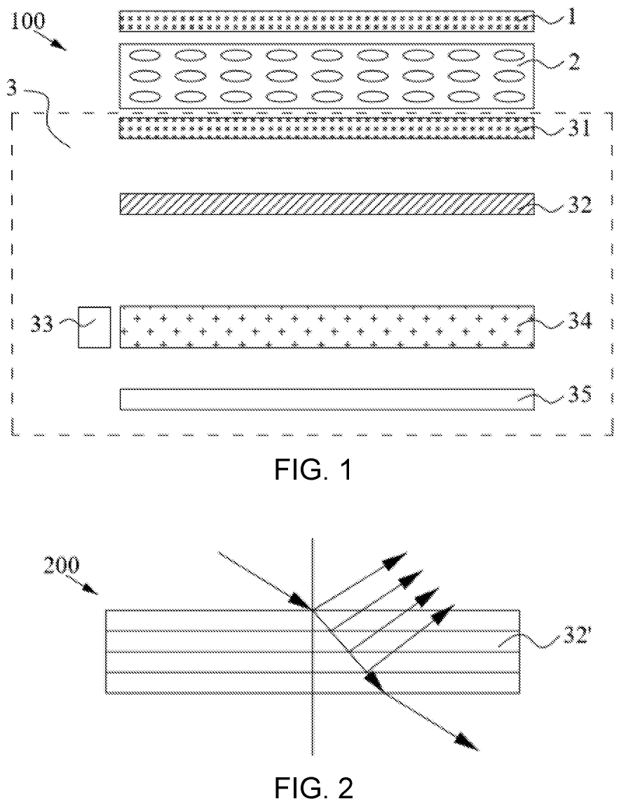

The present application provides a liquid crystal display device, and specifically refers to FIGS. 1-7.

In the thin film transistor-liquid crystal display panel, there are polarizers on the array substrate and the color filter substrate, and the maximum transmittance of the two polarizers under the action of the liquid crystal is only 40%. Regarding polarizers, iodine-based polyvinyl alcohol (PVA) type polarizers are commonly used, and the principle of polarization is that iodine molecules absorb polarized light parallel to the absorption axis and transmit polarized light perpendicular to the absorption axis. Theoretically, the maximum transmittance of such polarizer is 50%. However, the transmittance thereof is often less than 45% due to manufacturing processes.

Please refer to FIG. 1, in order to solve the problem of low transmittance of the liquid crystal display panel, the polarizer can be improved. There is a method for increasing the incident light of the polarizer, that is, a specific double brightness enhancement film (DBEF) is disposed between the backlight module and the polarizer of the array substrate, and the transmittance is increased by utilizing the light circulation. The double brightness enhancement film is a multilayer film structure. 800 layers of films of various thicknesses and various refractive indices are integrated in a thickness of 100 um. If the light passing axis of the double brightness enhancement film 32 is adjusted to be consistent with the polarization direction of the polarizer 31 on the array substrate, the light parallel to the polarizer 31 passes through the double brightness enhancement film 32, and the light perpendicular to the polarizer 31 is first reflected by the double brightness enhancement film 32, and then is reflected by the reflection sheet 35 at the bottom of the backlight module 3, and then passes through the double brightness enhancement film 32 after the polarization direction is changed, again. The dual brightness enhancement film 32 can increase the overall brightness of the entire backlight module 3 by 40% to 45%.

The main principle of such dual brightness enhancement film 32 is to increase the reflection of light by changing the polarization state of the light. In practice, the light needs to be incident into the dual brightness enhancement film 32 at a specific angle to achieve a higher polarization state selection effect. In addition, the direction of polarization of the light reflected by the dual brightness enhancement film 32 does not change significantly, and the light requires multiple reflections for being transmitted, so that there is still a large loss before passing through the polarizer 31 on the array substrate.

According to the principle that the dual brightness enhancement film can selectively reflect the polarized light, the present application provides a novel liquid crystal display device, which adopts a multilayer film polarizer structure to replace the polarizer on the array substrate. The incident light is incident into the multilayer film polarizer at a Brewster angle by adjusting the structure of the light guide plate while simultaneously fitting the λ/4 wave plate added between the multilayer film polarizer and the light guide plate.

With Brewster's theorem, as the incident light is incident into a transparent medium at an angle θ (which satisfies tan θ=n, and n is a refractive index of the multilayer film), the reflected light is polarized light of which polarization direction is perpendicular to the incident surface (i.e., S Component), and the transmitted light is partially polarized light. When the multilayer films are stacked together, and the natural light is incident at the Brewster angle, each time the light encounters an interface, the transmitted light is 100% transmitted by the polarized light (i.e., the P component) of which the polarization direction is parallel to the incident surface, and about 15% of the light is reflected by the S component, as shown in FIG. 2. After multiple reflections and refractions, the reflected light is S component linearly polarized light, and the transmitted light is almost all P component linearly polarized light, thus the multilayer film can be used as a polarizer. Then, a λ/4 wave plate is added between the backlight and the lower reflection sheet, and the o optical axis and the e optical axis of the λ/4 wave plate are adjusted at an angle of 45° with the S component. The S component reflected by the multilayer film is changed to a left-handed (or right-handed) circularly polarized light after passing through the λ/4 wave plate, and then is changed to a right-handed (or left-handed) circularly polarized light after being reflected by the lower reflection sheet of the backlight module, and then is changed to a P component linearly polarized light after passing through the λ/4 wave plate, again. Namely, the working principle of the liquid crystal display device is to convert the natural light entering the multilayer film polarizer into polarized light, and the λ/4 wave plate changes the polarization direction of the light that has not passed through the multilayer film polarizer, and then transmits the light. The transmittance reaches 100%.

### Embodiment One

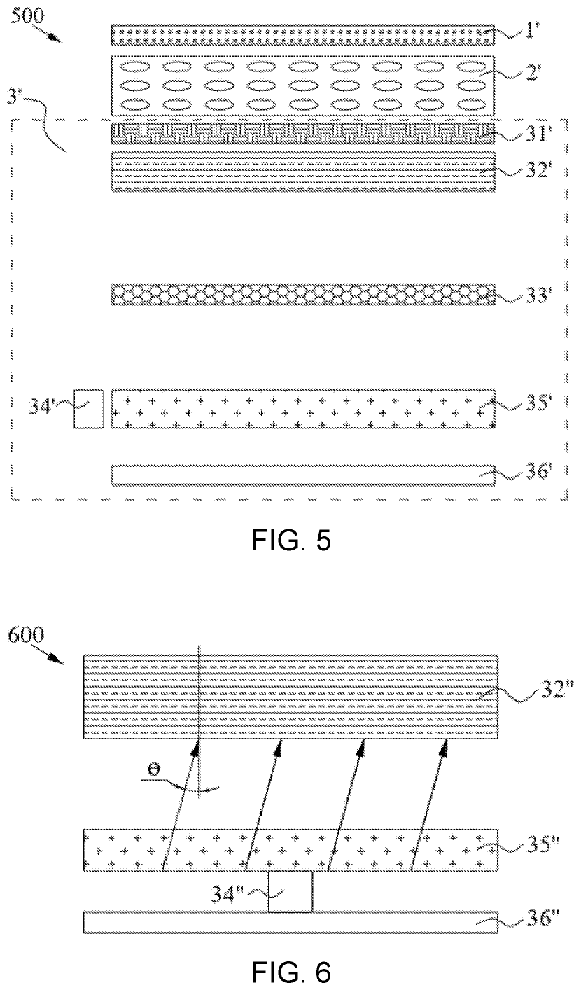

Please refer to FIG. 5. The present application provides a liquid crystal display device, including a common polarizer 1′, a liquid crystal layer 2′ and a backlight module 3′; wherein the common polarizer 1′ is disposed on a color film substrate; the liquid crystal layer 2′ is disposed under the common polarizer 1′, and between the common polarizer 1′ and the backlight module 3′; wherein the backlight module 3′ further includes: a diffusion sheet 31′, a multilayer film polarizer 32′, a λ/4 wave plate 33′, a light source 34′, a light guide plate 35′ and a reflection sheet 36′; the diffusion sheet 31′ is disposed under the liquid crystal layer 2′ and is right opposite to the common polarizer 1′; the multilayer film polarizer 32′ includes at least one film disposed right under the diffusion sheet 31′; the λ/4 wave plate 33′ is disposed between the multilayer film polarizer 32′ and the light guide plate 35′ to act together with the light guide plate 35′ and the reflection sheet 36′ to convert linearly polarized light into circularly polarized light, and the circularly polarized light is converted into linearly polarized light; the light source 34′ is configured to provide light, and is disposed on a side of the light guide plate 35′ or under the light guide plate 35′; the light guide plate 35′ is disposed under the λ/4 wave plate 33′; and the reflection sheet 36′ is disposed under the light guide plate 35′ and at a bottom of the backlight module 3′. The backlight module 3′ described in this embodiment is a side light type backlight module, and the backlight 34′ is disposed on the left side of the light guide plate 35′.

According to a preferred embodiment provided by the present application, the multilayer film polarizer is made of polyethylene terephthalate or a polyvinyl alcohol polymer plastic material having good light transmittance. Meanwhile, for achieving good polarizing performance, a number of layers of the multilayer film polarizer provided by the present application is greater than 500. A total thickness of the multilayer film polarizer does not exceed 100 um, and each film of the multilayer film polarizer possesses a thickness of 95 to 195 nm.

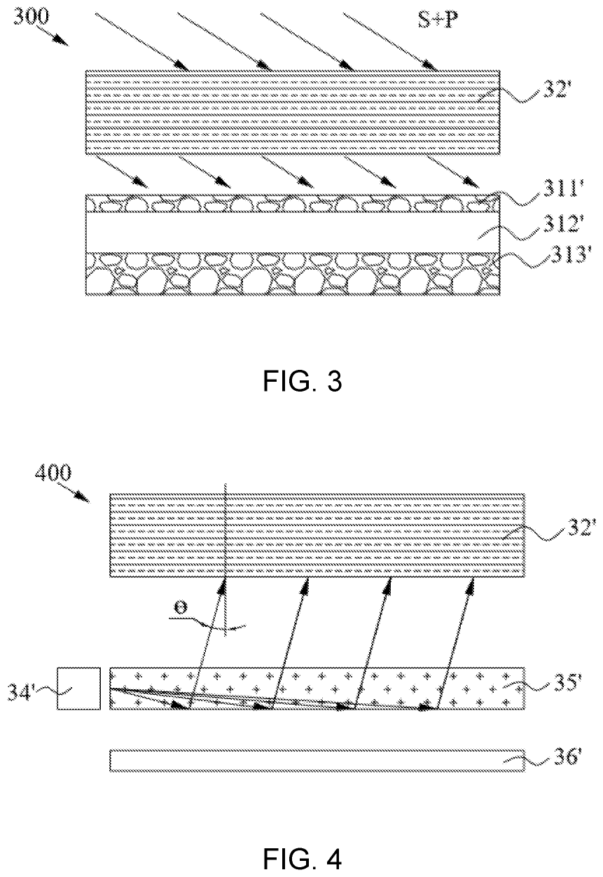

According to a preferred embodiment provided by the present application, a diffusion sheet 31′ needs to be attached to the multilayer film polarizer 32′, and the diffusion sheet 31′ is made of a polymer material of polyethylene terephthalate or polycarbonate as a substrate, and an acrylic resin 313′ material is used as a diffusion layer and a protective layer. Diffusion particles in the diffusion layer are transparent polymethyl methacrylate particles 311′ having irregular particle diameters. The function of the particles is mainly to diffuse the light, and to atomize the light refracted by the multilayer film polarizer 32′ in a specific direction to make the light more uniform and fine. Referring to FIG. 3, the light entering the multilayer film polarizer 32′ and the diffusion sheet 31′ is viewed from the bottom to the top.

Referring to FIG. 4, a front surface of the light guide plate 35′ is a flat surface, and a bottom surface of the light guide plate is a mesh surface (dot surface). The size of the dot surface, the spacing between the dots, and the depth of the dots can be adjusted. Thus, the incident angle of the reflected light into the multilayer film polarizer is the Brewster angle, that is, the incident angle θ satisfies: tan θ=n, wherein n is the refractive index of the multilayer film.

According to a preferred embodiment provided by the present application, it is necessary to attach a λ/4 wave plate 33′ to the light guide plate 35′. The λ/4 wave plate 33′ is a phase difference plate, and is made by uniaxially stretching a polymer material of polymethyl methacrylate or polyethylene terephthalate. The film molecules achieve alignment as being stretched to exhibit a birefringence effect. When the thickness of the film is λ/4 (ne−no), the transmitted light differs in phase by π/2 in the o direction and the e direction. When the light polarization direction is at an angle of 45° to the o axis and the e axis, the effect is to convert the linearly polarized light into circularly polarized light and to convert the circularly polarized light into linearly polarized light.

According to a preferred embodiment provided by the present application, the common polarizer 1′ is an iodine-based polyvinyl alcohol type polarizer, and a polarization direction of the common polarizer 1′ is perpendicular to a direction of the multilayer film polarizer 32′.

### Embodiment Two

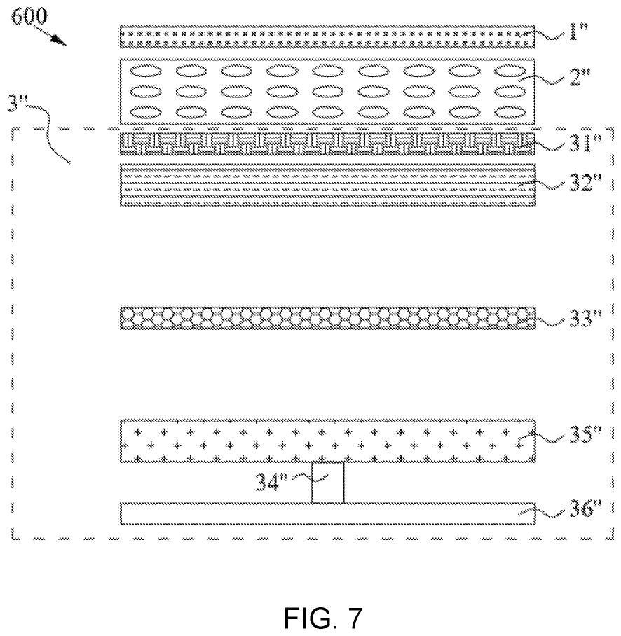

Please refer to FIG. 6 and FIG. 7. The present application provides a liquid crystal display device, including a common polarizer 1″, a liquid crystal layer 2″ and a backlight module 3″; wherein the common polarizer 1″ is disposed on a color film substrate; the liquid crystal layer 2″ is disposed under the common polarizer 1″, and between the common polarizer 1″ and the backlight module 3″; wherein the backlight module 3″ further includes: a diffusion sheet 31″, a multilayer film polarizer 32″, a λ/4 wave plate 33″, a light source 34″, a light guide plate 35″ and a reflection sheet 36″; the diffusion sheet 31″ is disposed under the liquid crystal layer 2″ and is right opposite to the common polarizer 1″; the multilayer film polarizer 32″ includes at least one film disposed right under the diffusion sheet 31″; the λ/4 wave plate 33″ is disposed between the multilayer film polarizer 32″ and the light guide plate 35″ to act together with the light guide plate 35″ and the reflection sheet 36″ to convert linearly polarized light into circularly polarized light, and the circularly polarized light is converted into linearly polarized light; the light source 34″ is configured to provide light, and is disposed on a side of the light guide plate 35′ or under the light guide plate 35″; the light guide plate 35″ is disposed under the λ/4 wave plate 33″; and the reflection sheet 36″ is disposed under the light guide plate 35″ and at a bottom of the backlight module 3″. The backlight module 3″ described in this embodiment is a direct light type backlight module, and the backlight 34″ is disposed under the light guide plate 35″.

According to a preferred embodiment provided by the present application, the multilayer film polarizer 32″ is made of polyethylene terephthalate or a polyvinyl alcohol polymer plastic material having good light transmittance. Meanwhile, for achieving good polarizing performance, a number of layers of the multilayer film polarizer 32″ provided by the present application is greater than 500. A total thickness of the multilayer film polarizer does not exceed 100 um, and each film of the multilayer film polarizer 32″ possesses a thickness of 95 to 195 nm.

Referring to FIG. 4, a front surface of the light guide plate 35″ is a flat surface, and a bottom surface of the light guide plate is a mesh surface (dot surface). The size of the dot surface, the spacing between the dots, and the depth of the dots can be adjusted. Thus, the incident angle of the reflected light into the multilayer film polarizer 32″ is the Brewster angle, that is, the incident angle θ satisfies: tan θ=n, wherein n is the refractive index of the multilayer film.

According to a preferred embodiment provided by the present application, it is necessary to attach a λ/4 wave plate 33″ to the light guide plate 35″. The λ/4 wave plate 33″ is a phase difference plate, and is made by uniaxially stretching a polymer material of polymethyl methacrylate or polyethylene terephthalate. The film molecules achieve alignment as being stretched to exhibit a birefringence effect. When the thickness of the film is λ/4 (ne−no), the transmitted light differs in phase by π/2 in the o direction and the e direction. When the light polarization direction is at an angle of 45° to the o axis and the e axis, the effect is to convert the linearly polarized light into circularly polarized light and to convert the circularly polarized light into linearly polarized light.

According to a preferred embodiment provided by the present application, the common polarizer 1″ is an iodine-based polyvinyl alcohol type polarizer. A polarization direction of the common polarizer 1″ is perpendicular to a direction of the multilayer film polarizer 32″.

The liquid crystal display device provided by the embodiments of the present application is described in detail as aforementioned, and the principles and implementations of the present application have been described with reference to specific illustrations. The description of the foregoing embodiments is merely for helping to understand the technical solutions of the present application and the core ideas thereof; those skilled in the art should understand that the technical solutions described in the foregoing embodiments may be modified, or some of the technical features may be equivalently replaced; and the modifications or replacements do not deviate from the spirit and scope of the technical solutions of the embodiments of the present application.

What is claimed is:

1. A liquid crystal display device, including a common polarizer, a liquid crystal layer and a backlight module;
wherein the common polarizer is disposed on a color film substrate;
the liquid crystal layer is disposed under the common polarizer, and between the common polarizer and the backlight module;
wherein the backlight module further includes: a diffusion sheet, a multilayer film polarizer, a λ/4 wave plate, a light source, a light guide plate and a reflection sheet;
the diffusion sheet is disposed under the liquid crystal layer and is right opposite to the common polarizer;
the multilayer film polarizer includes at least one film disposed right under the diffusion sheet;
the λ/4 wave plate is disposed between the multilayer film polarizer and the light guide plate;
the light guide plate is disposed under the λ/4 wave plate, and a front surface of the light guide plate is a flat surface, and a bottom surface of the light guide plate is a mesh surface; and
the reflection sheet is disposed under the light guide plate and at a bottom of the backlight module.

2. The liquid crystal display device according to claim 1, wherein the backlight module is a side light type backlight module or a direct light type backlight module.

3. The liquid crystal display device according to claim 1, wherein the multilayer film polarizer is made of polyethylene terephthalate or a polyvinyl alcohol polymer material.

4. The liquid crystal display device according to claim 3, wherein a number of layers of the multilayer film polarizer is greater than 500.

5. The liquid crystal display device according to claim 4, wherein a total thickness of the multilayer film polarizer does not exceed 100 um.

6. The liquid crystal display device according to claim 4, wherein each film of the multilayer film polarizer possesses a thickness of 95 to 195 nm.

7. The liquid crystal display device according to claim 1, wherein the diffusion sheet is made of a polymer material of polyethylene terephthalate or polycarbonate as a substrate, and an acrylic resin material is used as a diffusion layer and a protective layer.

8. The liquid crystal display device according to claim 6, wherein diffusion particles in the diffusion layer are polymethyl methacrylate particles having irregular particle diameters.

9. The liquid crystal display device according to claim 1, wherein the λ/4 wave plate is made of polymer material of polymethyl methacrylate or polyethylene terephthalate.

10. The liquid crystal display device according to claim 1, wherein the common polarizer is an iodine-based polyvinyl alcohol type polarizer.

11. The liquid crystal display device according to claim 9, wherein a polarization direction of the common polarizer is perpendicular to a direction of the multilayer film polarizer.

12. A liquid crystal display device, including a common polarizer, a liquid crystal layer and a backlight module;
wherein the common polarizer is disposed on a color film substrate;
the liquid crystal layer is disposed under the common polarizer, and between the common polarizer and the backlight module;
wherein the backlight module further includes: a diffusion sheet, a multilayer film polarizer, a λ/4 wave plate, a light source, a light guide plate and a reflection sheet;
the diffusion sheet is disposed under the liquid crystal layer and is right opposite to the common polarizer;
the multilayer film polarizer includes at least one film disposed right under the diffusion sheet;
the λ/4 wave plate is disposed between the multilayer film polarizer and the light guide plate;
the light guide plate is disposed under the λ/4 wave plate; and
the reflection sheet is disposed under the light guide plate and at a bottom of the backlight module.

13. The liquid crystal display device according to claim 12, wherein the backlight module is a side light type backlight module or a direct light type backlight module.

14. The liquid crystal display device according to claim 12, wherein the multilayer film polarizer is made of polyethylene terephthalate or a polyvinyl alcohol polymer material.

15. The liquid crystal display device according to claim 14, wherein a number of layers of the multilayer film polarizer is greater than 500.

16. The liquid crystal display device according to claim 15, wherein a total thickness of the multilayer film polarizer does not exceed 100 um.

17. The liquid crystal display device according to claim 15, wherein each film of the multilayer film polarizer possesses a thickness of 95 to 195 nm.

18. The liquid crystal display device according to claim 12, wherein the diffusion sheet is made of a polymer material of polyethylene terephthalate or polycarbonate as a substrate, and an acrylic resin material is used as a diffusion layer and a protective layer.

19. The liquid crystal display device according to claim 17, wherein diffusion particles in the diffusion layer are polymethyl methacrylate particles having irregular particle diameters.

20. The liquid crystal display device according to claim 12, wherein the λ/4 wave plate is made of polymer material of polymethyl methacrylate or polyethylene terephthalate.
